(19) United States
(12) Patent Application Publication
(10) Pub. No.: US 2007/0277940 A1
(43) Pub. Date: Dec. 6, 2007

(54) Blind Slat Having Sealed Openings and Mimic Wooden Traces

(76) Inventor: Chin-Fu Chen, Taichung City (TW)

Correspondence Address: APEX JURIS, PLLC;TRACY M HEIMS, LAKE CITY CENTER, SUITE 410, 12360 LAKE CITY WAY NORTHEAST, SEATTLE, WA, 98125, US

(21) Appl. No.: 11/830,254

(22) Filed: Jul. 30, 2007

Related U.S. Application Data
(63) Continuation-in-part of application No. 11/323,495, filed on Jan. 3, 2006.

(51) Int. Cl. E06B 9/386

(52) U.S. Cl. 160/236

(57) ABSTRACT

A blind slat structure having sealed openings and mimic wooden traces includes a plastic slat formed through injection molds with cavities formed on the surface and has a hollow interior and two ends each having an opening. Each of the two ends is inserted into a sealing slot of a fusion machine mold to be fused to become a wedge-shaped closed end so that the slat becomes a hollow body with two closed ends. The sealed slat is printed a number of times to form a printed layer on the surface mimic wooden traces. The slat thus formed has a lighter weight and is less likely to warp or deform. The mimic wooden traces on surface provide retrospective appeal.

This application is a continuation-in-part, and claims priority to U.S. patent application Ser. No. 11/323,495 filed on Jan. 3, 2006, entitled “HOLLOW SLAT STRUCTURE FOR BLINDS”.

### FIELD OF THE INVENTION

The present invention relates to a blind slat and particularly to a hollow slat structure for blinds that has colored traces and cavities on the surface and a selected thickness to prevent warping and deformation.

### BACKGROUND OF THE INVENTION

A conventional blind slat as shown in FIG. 1 mainly is a thin blade formed by extrusion of plastics. The thin blade has two sides threaded through by threads to form a full set of blind. When in use, dusts inevitably deposit on the slat. Hence the slat needs cleaning after being used for a period of time. As the thin blade has little bracing power, it tends to warp and deform when being wiped for cleaning. Some plastic slats are heavier and tend to sag on two ends. Moreover, most conventional plastic slats are made in one color. The style is simple and bland. Compared with fabric window coverings, the style and pattern of the blind slat are not very appealing. Furthermore, the plastic slat generally cannot block light very well. Sound isolation effect also is poor. Some blind producers tried to increase the slat thickness to overcome the warping and deforming problem. But the solid plastic slat is heavier. As the plastic blind consists of multiple slats threading by threads, increasing weight creates a heavier load on the threads that becomes another concern.

### SUMMARY OF THE INVENTION

In view of the aforesaid disadvantages occurred to the conventional blind slats, the primary object of the present invention is to provide a blind slat with sealed openings and mimic wooden traces. It has a hollow slat structure made from plastics by injection with cavities formed on the surface and an opening at each of two ends. Each of the two ends is inserted into a sealing slot of a fusion machine mold to be fused in a wedge shape. Then the slat is printed a number of times through a calender to form an ink layer on the surface thereof mimic wooden traces. The resulting slat has a selected thickness and becomes a hollow member with two sealed ends. It has a lighter weight and is less likely to warp or deform. The surface is printed with mimic wooden traces and has three dimensional cavities. It looks like wood and provides retrospective appeal.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional blind slat.

FIG. 2 is a perspective view of an embodiment of a slat of the present invention before two ends being sealed.

FIG. 3 is a schematic view of an embodiment of a slat of the present invention in a fabricating condition.

FIG. 4A is a perspective view of an embodiment of a slat of the present invention.

FIG. 4B is a cross section taken on line 4B-4B in FIG. 4A.

FIG. 4C is a cross section taken on line 4C-4C in FIG. 4A.

### DETAILED DESCRIPTION OF THE PREFERRED EMBODIMENT

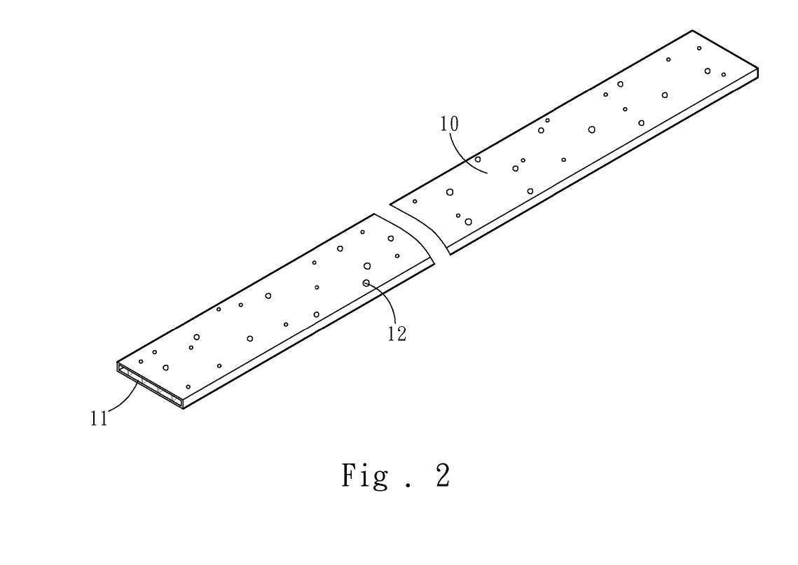

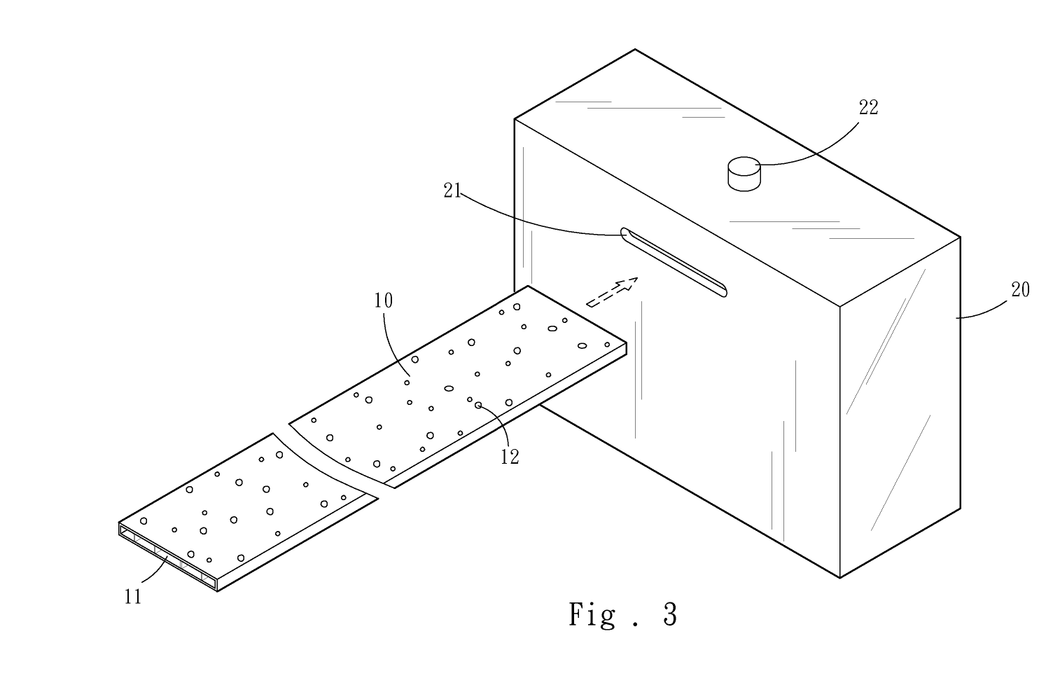

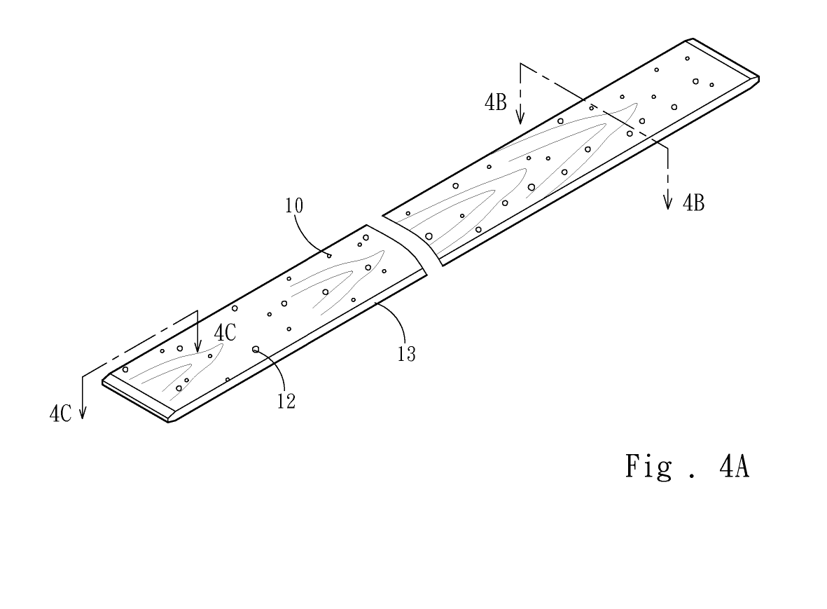

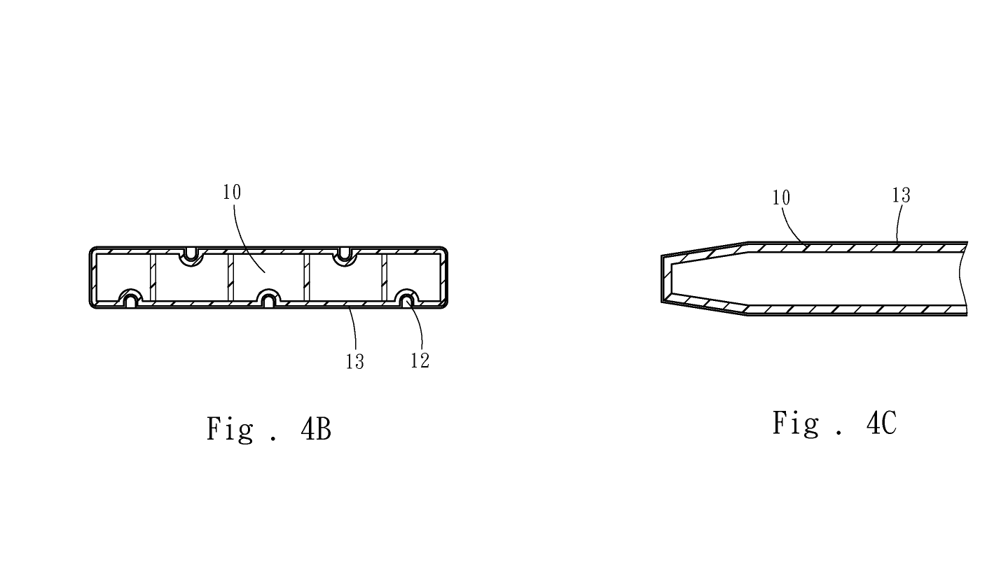

Please refer to FIGS. 2 and 3, the blind slat with sealed openings and mimic wooden traces according to the invention includes a plastic slat 10 formed by injection through molds which have a plurality of bulged spots such that the resulting slat 10 has a plurality of cavities 12 on the surface and a hollow interior running through to form an opening 11 at each of two ends thereof. Each end with the opening 11 is inserted into a sealing slot 21 of a mold of a fusion machine 20 to be fused to form a closed end in a wedge shape. The sealing slot 21 is formed with a width mating the slat 10. After the two ends are fused, the slat 10 becomes a hollow body with two closed ends as shown in FIGS. 4A, 4B and 4C. Then the slat 10 is pressed for a number of times through a pair of rollers of a calender to form a printed layer 13 mimic wooden traces on the surface of the slat 10.

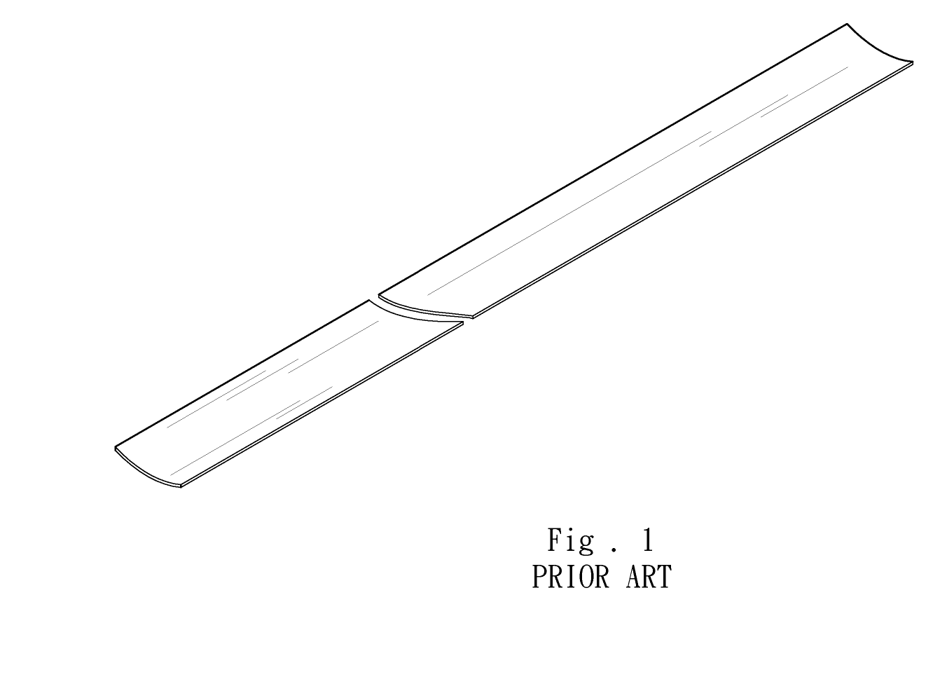

By means of the structure set forth above, the slat 10 is formed with a selected thickness and is less likely to warp or deform. The surface of the slat 10 is printed with the printed layer 13 mimic wooden traces and has the cavities 12 formed thereon. It looks like wood and has a retrospective appeal. Because the slat 10 is a sealed hollow body, it can provide an improved sound isolation effect. It also can block light more effectively than the conventional blind slat as shown in FIG. 1. Even if the indoor light is stronger than the outdoor environment, it still can block peeping from outside. Moreover, the fabrication of sealing two ends of the slat 10 can be done easily and rapidly. The fusion machine 20 has a temperature controller 22 to control the temperature of the sealing mold. Thus once each opening end 11 of the slat 10 is inserted into the sealing slot 21, the high temperature mold can fuse and seal the opening 11 quickly to form a closed end.

Actual prototypes and samples of the invention have been made. Test results confirmed that they have achieved the object and desired efficacy of the invention previously discussed.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A blind slat having sealed openings and mimic wooden traces comprising a slat made from plastics formed by injection molds which have bulged spots to from a plurality of cavities on the surface of the slat which has a hollow interior and two ends each having an opening, each of the two ends being inserted into a sealing slot of a fusion machine mold to be fused to become a wedge-shaped closed end so that the slat becomes a hollow body with two closed ends; the sealed slat being printed a plurality of times through a pair of rollers of a calender to form a printed layer on the surface thereof mimic wooden traces.
